(19) United States
(12) Patent Application Publication
(10) Pub. No.: US 2009/0220649 A1
(43) Pub. Date: Sep. 3, 2009

(54) Nutritionally Balanced Food or Beverage Product

(75) Inventor: Glenda Ryan, Christchurch (NZ)

Correspondence Address: MERCHANT & GOULD PC, P.O. BOX 2903, MINNEAPOLIS, MN, 55402-0903, US

(73) Assignee: SAPPORO HOLDING LIMITED

(21) Appl. No.: 11/886,365

(22) PCT Filed: Mar. 14, 2006
(86) PCT No.: PCT/NZ2006/000047

§ 371 Date: Apr. 24, 2009

(30) Foreign Application Priority Data
Mar. 14, 2005 (NZ) 538828
Jul. 1, 2005 (NZ) 541066

(51) Int. Cl. A23L 1/29; A23L 1/08; A23L 1/09

(52) U.S. Cl. 426/73; 426/72; 426/232

(57) ABSTRACT

A nutritionally balanced food or beverage product suitable for use as a partial or total meal replacement, wherein for any given quantity consumed the relative ratios of calories, protein, fat, saturated fat, carbohydrate, sugar, fibre and one or more vitamins and minerals are nutritionally balanced.

### FIELD OF THE INVENTION

This invention relates to a nutritionally balanced food or beverage product for human consumption.

### BACKGROUND ART

Modern day food technologists and dieticians have developed and created food and beverage products of various types and kinds for many different purposes. For example, muesli bars, which are a typically consumed snack or meal substitute. However, these are commonly very low in fat but very high in carbohydrate, particularly sugar. Other bar type products created for those wishing to build muscle bulk are very low in carbohydrate, but high in protein.

Existing products which are developed to with a particular nutritional goal in mind, be it low fat, high protein, low carbohydrate, high in fibre, or low in calorie content generally deal focus on that goal only, with little or no attention being given to the nutritional profile of all of the other macronutrients.

In the past, where greater attention has been given to trying to produce balance in one or other aspects of the remainder of the nutritional profile of the food or beverage product this has typically been achieved by the addition of an artificial additive of one sort or another, thereby losing the synergistic nutritional benefits derived from taking a more holistic design and development approach using real and natural ingredients.

There is a need for a concentrated, condensed, pleasant tasting and conveniently formatted nutritionally balanced food or beverage product which can be used as partial or total meal replacement for people engaged in sporting or other pursuits, school children, and those whose time commitments do not adequately allow for stopping for a meal break.

It is an object of the present invention to address this perceived need, or at least to provide the public with a useful choice.

### SUMMARY OF THE INVENTION

According to the present invention there is provided a nutritionally balanced food or beverage product suitable for use as a partial or total meal replacement, wherein for any given quantity consumed the relative ratios of calories, protein, fat, saturated fat, carbohydrate, sugar, fibre and one or more vitamins and minerals are nutritionally balanced.

For the purposes of the present application the term “nutritionally balanced” is intended to refer to the relative proportions of calories, protein, fat, saturated fat, carbohydrate, sugar, fibre and one or more vitamins and minerals as recommended by an appropriately recognised governmental or quasi-nongovernmental institution. For example, in its preferred form the product of the present invention contains the same relative proportions of the recommended daily intake of calories, protein, fat, saturated fat, carbohydrate, sugar, fibre and one or more vitamins and minerals as specified in the Australia-New Zealand Joint Food Standards Code.

Such a product is suitable to act as a simple and convenient ergogenic aid, particularly but not exclusively for persons, whether adult or child, participating in sports or other forms of exercise, or people who are under time pressures and for whom, from time to time, stopping for meal breaks is not convenient. The product of this invention is also useful in addressing general hunger or fatigue in the wider population, and in that regard is intended as suitable for use as a meal replacement.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components which it directly references, but also to other non-specified components or elements. This rationale will also be used when the term ‘comprised’ or ‘comprising’ is used in relation to one or more steps in a method or process.

The present invention also includes a method of manufacture of a food product according to the invention wherein all of the ingredients are combined together at a temperature below 100° C. so that the pre-existing beneficial attributes of the constituent parts are not degraded through being subjected to excessive heat for an extended time period during production.

A product according to this invention may comprise a baked or moulded edible bar, cookie or biscuit, or a beverage in the form of a shake or smoothie. A baked or moulded edible bar, or a shake or smoothie are preferred forms.

Optimally each complete serving of the product of this invention contains 33.3% of the recommended daily amount of calories, protein, fat, and carbohydrate.

Use of fibre in the product is advantageous because fibre influences the release of sugars, affects the binding of various components, and advantageously delays digestion. This means that a sustained, or filling, feel is produced which lasts for longer, and thus helps to reduce over eating. A high fibre content also assists in reducing the glycemic value of the product.

Preferably the ratio of complex carbohydrates to simple sugars is at least one to one, and more preferably three or more to one, thereby producing a low glycemic value product so as to prevent creating spikes in the blood glucose levels, thus reducing the risk to consumers of diseases such as coronary heart disease, obesity, and Type 2 diabetes.

Preferably the product contains a honey based sweetener, more preferably honey made from the nectar of the manuka bush, Leptospermum scoparium.

It is well-known that carbohydrate ingestion prior to, during, and after exercise enhances athletic performance and speeds recovery. Honey is a natural source of readily available carbohydrates providing approximately 17 grams of carbohydrates per tablespoon. Honey's unique carbohydrate composition (approximately equal amounts of fructose and glucose) makes its use desirable because it reduces the incidence of rebound hypoglycemia and provides sustained carbohydrate availability during exercise.

Because honey contains such a variety of carbohydrates and other nutrients, it functions more than just as a sweetener. The carbohydrates, major monosaccharides and minor oligosaccharides of honey are responsible for some of its key functional properties. The ability of honey to hold moisture and extend shelf-life, its microwave reactivity, and its ability to promote color and flavors development are all related to its carbohydrate composition.

In addition to having its own sweetener functionality and capability, honey is also a potent sweetness enhancer. In that regard, honey enhances and magnifies the residual sweetness of a product beyond the level of sweetness that the mere introduction of honey alone would produce. This is particularly so when added to products with low levels of sweetness.

Additional or alternative sources of natural sugars can be derived from fruits, such as apricots, apples, berry or tropical fruits, which can also be used to impart a desirable flavour profile to the food product. Other additional or alternative flavouring agents potentially include chocolate, as well as a range of savoury options.

Desirably any fat sources used should comprise a ratio of poly-unsaturated and mono-unsaturated fatty acids versus saturated fats. More preferably including use of oils with omega-fatty acids.

Optionally a food product according to the present invention should include various key vitamins and minerals, such as vitamins A, B1, B2, B6, B12, C, D, and E, and niacin and foliate, as well as calcium, iodine, iron, magnesium, phosphorus and zinc at levels corresponding to the nutritionally balanced levels of carbohydrate, fat, protein and fibre. For example, if the food product contains 33.3% of these of the recommended daily intake levels of these components then the levels of key vitamins and minerals should also be at least 33.3% of recommended minimum daily intake levels.

The product should have the taste, texture and appearance of real food.

Use of polydextrose, such as from the Litesse® family of modified polydextrose is considered desirable to enhance mouth feel and textural qualities without the need for more traditional carriers of such characteristics, sugars and fats, which tend to render food unduly high in carbohydrates and fats.

Alternatively, and more preferably Acacia gum can be used in place of polydexrose. Acacia gum provides a number of further advantages in that it is able to act as a moisture sink, stopping the product from being sticky to the touch. Acacia gum is also a source of biofidogenic fibre, which means that it promotes the growth of desirable gastrointestinal bacteria.

Desirably, but not essentially, any product according to the present invention should contain largely natural ingredients, be free from genetically modified materials, and contain no artificial colours, flavours or preservatives. Optionally it may contain organically produced and certified ingredients.

Further, it is envisaged that an embodiment of the invention may be produced which is substantially free of known allergens such as gluten/wheat, lactose/dairy products, eggs and nuts and sesame seeds, and yeast.

An important attribute of the present invention is that the product must be substantially homogenous throughout. Each portion, bite or mouthful consumed must itself be substantially nutritionally balanced, containing substantially the same relative proportion of fat, protein, carbohydrate and dietary fibre as every other.

The key advantage that this characteristic of the food product has is that whether the whole serving is consumed, or just a portion of it, the consumer has always consumed a nutritionally balanced quantity.

Officially recommended daily intakes of energy, carbohydrate, protein, fat, dietary fibre, and essential vitamins and minerals vary slightly from one official organisation to another. However, what varies even more is the calorific consumption needs of one individual compared to another—which is dependent on age, gender, metabolic rate, and level of activity regularly engaged in. Further, and individual's calorific requirements can vary from one day to another based on the activities engaged in on any give day.

While the packaged “serving” of a food product according to this invention may be designed to satisfy a specific portion of the recommended daily intake, anyone consuming any portion of the serving will advantageously receive a balanced input, so that, for example, a child or an elderly person who may only consume half a serving, will receive the same nutritionally balanced benefit as a young man or woman who consumes the entire serving, or perhaps slightly more. It doesn't matter how much the consumer eats, they always get a nutritionally balanced intake.

Each serving of the food product of the present invention preferably contains 33.3% of the recommended daily intake of energy, carbohydrate, protein, fat, dietary fibre, and key vitamins and minerals. However, it is within the scope of the invention envisaged that the serving size could be from 10% to 33.3%.

As the food product of the present invention is intended to be used by consumers who may not be in a position to take a proper meal break the product must be sized and of a weight to facilitate being easily and conveniently carried with the consumer. In that regard, a serving of the product should preferably weigh between 50 grams and no more than 250 grams depending on the proportion of the recommended daily intake of dietary needs it contains, and should preferably take up between 25 cm³ and no more than 250 cm³ of volume, again depending on the proportion of the recommended daily intake of dietary needs it contains.

Preferably each serving of the product of the invention should be individually wrapped. Optionally each serving may contain two separately wrapped half servings. In one such embodiment one half serving may be savoury in flavour, and the other sweet to taste, but each having the same level of recommended daily dietary needs. Alternatively, each half serving may contain a different level of the recommended daily dietary needs, but taken together combine to a specific proportion of the recommended daily dietary requirements.

Advantageously a food product according to the present invention has a shelf life of at least 3 months, in ambient conditions.

In a second broad aspect of the invention there is provided a method of manufacture of a food product of the first aspect, the method comprising the steps of:
a: weighting out the various individual ingredients and preparing each one according to the product requirements; and
b: tempering the bulk dry ingredients to bring them to room temperature or slightly above; and
c: pre-blending the dry ingredient components of the syrup mixture to ensure homogeneity; then
d: blending and heating the syrup to a temperature less than 100° C.; then
e: mixing the heated syrup with the bulk dry ingredients and blending to form a substantially homogeneous mix of predetermined density; then
f: forming the homogeneous mix into predetermined size pieces, wherein each piece contains substantially the same quantity of product mix as all of the others; then
h: wrap each piece promptly to avoid take up of moisture from the air.

Preferably the syrup is heated to no more than 95° C. in step (d).

Desirably the syrup is at between 80° C. and 95° C. during step (e).

Optionally the pieces of homogeneous mix may be formed at step (f) via a process which includes forming the mix into a sheet of even thickness and then cutting the sheet into the pieces, alternatively the pieces can be formed by an extrusion process, or by a moulding process.

In a third broad aspect of the invention there is provided a method of manufacture of a beverage product of the first aspect, the method comprising the steps of:

Steps (a) to (e) of the second broad aspect above; then
i. blending the homogeneous mix with a predetermined quantity of water to form a substantially smooth and homogeneous fluid; then
ii. dispensing predetermined volumes of the fluid into packaging containers.

The invention is further described by means of examples, but not in any limitative sense.

### BRIEF DESCRIPTION OF THE DRAWING

FIG. 1 illustrates the temperature profile of the syrup used in the manufacture of a moulded bar product according to a preferred embodiment of the present invention during its production.

### DETAILED DESCRIPTION OF PREFERRED EMBODIMENTS

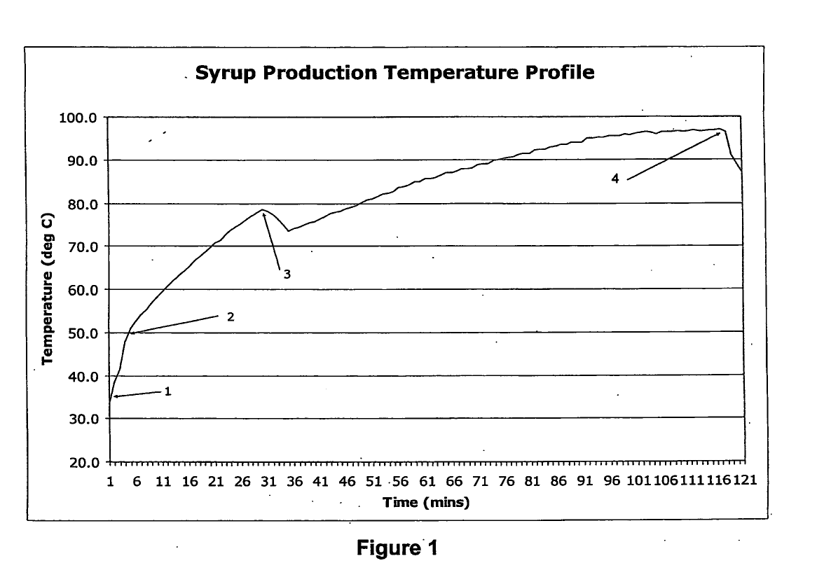

A preferred embodiment of the present invention will now be described with reference to the accompanying drawing, FIG. 1.

The table below details the major macro-nutritional qualities of a chewable bar food product according to a preferred embodiment of the invention, weighting a net total of 165 g:

| | Quantity/ | | % of RDI/ | % by weight/ |
|---|---|---|---|---|
| | serving | | serving | serving |
| Energy | 2900 | KJ | 33.3% | 100% |
| Protein | 16.7 | g | 33.3% | 10.1% |
| Fat, Total | 23.3 | g | 33.3% | 14.1% |
| Fat, Saturated | 8.0 | g | 33.3% | 4.8% |
| Carbohydrate, Total | 90.2 | g | 33.3% | 54.7% |
| Carbohydrate, Sugar | 30.0 | g | 33.3% | 18.2% |
| Dietary Fibre | 10.0 | g | 33.3% | 6.1% |

The chewable food bar is manufactured from various ingredients. These essentially comprise three separate sets, namely, liquid ingredients for use in the production of the syrup mixture, dry ingredients for the syrup mixture, and bulk muesli ingredients.

The liquid ingredients for the syrup mixture include rice bran oil, palm oil, manuka honey and glycerine. The dry ingredients for the syrup mixture include cornflour, Acacia gum and low dextrose equivalent maltodextrin. And the bulk muesli ingredients include raisins, dried apricots, rice flour; rolled oats, wheat flakes and soy nuggets.

In terms of nutritional profile of the bar, the bulk carbohydrate ingredients include multidextrin, wheat flakes, corn flour, rolled oats and rice flour, with natural sugars being substantially contributed by fruits, such as apricots and raisins, and honey, preferably Manuka honey. Protein is primarily provided as soy protein, although rolled oats and apricots are further significant protein sources. Vegetable oils such as rice bran oil, palm oil and palm kernel oil provide the major fat contributors and assist with carrying the flavours. Other major fat sources include wheat flakes.

The desired level of dietary fibre in part comes from rolled oats, but also from Acacia gum and dried apricots.

Additional humectants in the form of glycerine can be added, along with an emulsifier such as soy lecithin. Glycerine also has a sweetening effect.

Additional key vitamins and minerals, such as vitamins A, B1, B2, B6, B12, C, D, and E, and niacin and foliate, as well as calcium, iodine, iron, magnesium, phosphorus and zinc can be added to raise levels to 33.3% of recommended daily intake levels and combined with the remaining ingredients to form dispersed units within the matrix where otherwise deficient.

Cornflour helps to raise the complex carbohydrate level carbohydrates that don't have fibre or other nutrients associated with them, and decreases chewiness in the final product.

Rolled oats are used because they provide a cereal free of added sugar to use as base ingredient for the bar product. Bumped oats are an alternative, but generally less desirable because they have a hard texture.

Maltodextrin is included as a syrup ingredient to avoid the use of glucose: Use of a love dextrose equivalent maltodextrin minimises simple sugar content.

Rice bran oil not only has a good fatty acid composition and health giving properties, but it also is naturally very high in Vitamin E, an antioxidant, which means no artificial additive/preservative/antioxidant is required.

Soy nuggets are common in protein bars as a way of adding protein without the unpleasant taste often associated with powdered forms of protein. Most bars use the soy nuggets of 80% density. However, soy nuggets having a density of 60% open up the bar texture and add crunch to it's texture profile. In addition the soy protein in soy nuggets is what is termed “high quality” which means it contains a full complement of all the essential amino acids in appropriate proportions.

Wheatflakes are a low fat/high complex carbohydrate product which provide a means of increasing crunch and complex carbohydrates in the bar product.

Glycerine adds sweetness to the bar product without adding sugar, but also crucial as a humectant (to retard the drying out of the bar).

The manufacturing process commences with pre weighing of the rice flour and dried apricots. Next the dried apricots are chopped, with the rice flour being sprinkled over apricots as needed while they are being chopped. Rice flour should be added throughout the duration of the chopping process and all the rice flour must be added by the end of chopping, No water to be added. The rice flour is added at this point so that the dried apricot pieces do not stick to each other or to the chopper blades. Typically dried apricots would be chopped up with water as a lubricant. However, using rice flour helps to reduce the water in the formulation and boosts the carbohydrate levels. It also produces a much more free flow mix.

Next the fat (palm oil) and liquid ingredients for the syrup are weighed out and kept separately at or about room temperature. The dry ingredients for the syrup are also pre-weighed, and then placed into an air tight container until use.

Ingredients such as the wheat flakes and the soy nuggets are pre-weighed into separate bags and sealed in air-tight containers, with the remaining bulk muesli ingredients pre-weighed into a single container and sealed. The sealed containers are then tempered at room temperature.

The pre-weighed syrup dry ingredients, namely the salt, acacia gum, cornflour and maltodextrin, are then placed in a blender and mixed until homogenous. Blending in this manner stops lumps of cornflour forming when added to syrup liquids. Blending also ensures even distribution of acacia gum in the powders which is important for functional and nutritional reasons.

The normal method of syrup production for a bound cereal bar is to combine solid fats (unless low fat variety) and simple short chain sugars in the form of glucose syrup, high fructose corn syrup, sugar etc with water (and emulsifier) and boil to a set temperature—normally in the range of 110-116° C. This ensures the final syrup has a consistent total solids/moisture content.

However boiling to a higher temperature means:—
syrup boiling time is very long as it takes time to drive off water to achieve each degree rise in temperature; and
the final syrup is very viscous which makes mixing the syrup with the bulk muesli ingredients more difficult.

Referring specifically to the drawing, syrup production is commenced with the rice bran oil, lecithin, and palm oil placed into a heating vessel. The addition point is shown at 1 in the FIGURE.

Once the temperature in the vessel has reached approximately 50 C, at point 2 as shown in the FIGURE, the Manuka honey, glycerine and other liquid syrup ingredients are added. It is important that the contents of the vessel are kept sufficiently mixed at all times so that they do not boil, as any boiling will result in water evaporating from the syrup, and this is most likely to occur where liquid is in direct contact with the vessel surface.

Once any liquid ingredients such as honey and palm oil have completely melted, the pre-blended syrup dry ingredients are added to the vessel and fully mixed into the rest of syrup, shown at point 3 on the FIGURE.

After the dry syrup ingredients have been added the syrup should continue to be heated and mixed with constant stirring until syrup reaches 95° C. The maximum temperature of the syrup should be kept below 100° C. to ensure minimal loss of water. However the temperature must be above the gelatinisation temperature for starch (starches start to gel at 75 degrees Celsius, but full gelatinisation (in the presence of sufficient water) only occurs at around 90 to 95 degrees Celsius).

Heating to 95° C. also has pasteurisation effect on this portion of the product.

When the syrup is well mixed and at 95° C. it is considered ready, as shown at point 4 on the FIGURE, and should be used within an hour of preparation to ensure its temperature does not drop below 85° C. before being used.

In preparing the final mix the bulk dry ingredients are mixed together thoroughly, but carefully, as a first step to ensure substantial homogeneity.

Mixing of the final product is timed and the syrup temperature is controlled to ensure density of mix is as constant as possible. Care must be taken in the final mixing. Over mixing, or cooler (and thus more viscous) syrup, increases product density by crushing the wheat flakes and soy nuggets, and therefore the proportion of overall recommended daily intake levels of key vitamins, minerals, fat, protein and carbohydrate for a given bar volume is adversely affected. Mix density is also important to bar texture over shelf life.

In commencing the final mix the syrup is added in first so flavours and vitamins can be mixed in before the bulk muesli ingredients are added. Adding these after the bulk muesli ingredients would result in less loss of vitamins and flavour components as mixture would be lower temperature, but they would not be sufficiently homogenously distributed throughout mix. Adding the syrup first also eliminates the risk of a puddle of dry bulk muesli ingredient being left in the bottom of a mixing bowl that doesn't get mixed in.

Immediately after mixing has been completed it should be rolled out into a sheet to give an even layer of consistent thickness and density throughout, and to minimise crushing of the soy nuggets and wheat flakes. No water is used to lubricate the rolling process.

After forming into sheets the mix should be cooled through the cooling tunnel with temperature and time controlled to aim for a consistent level of moisture loss over the cooling process. The desired cooling tunnel temperature is 12 C. The temperature of the sheets at exit of the tunnel should be 18-20 C.

Once cool the sheets can be cut into predetermined sized pieces or bars, with each bar representing a predetermined portion of the recommended daily intake of key vitamins, minerals, fat, protein and carbohydrate.

The bars should be wrapped promptly after cutting to avoid uptake of moisture from the air, which reduces shelf life. Foil wrap has high barrier properties, and is therefore its use is desirable to assist shelf life.

Wherein the foregoing description reference has been made to integers or components having known equivalents then such equivalents are herein incorporated as if individually set forth.

Although this invention has been described by a way of example of possible embodiments, it is to be appreciated that improvements and/or modifications may be made thereto without departing from the scope of the appended claims.

1. A nutritionally balanced food or beverage product suitable for use as a partial or total meal replacement, wherein for any given quantity consumed the relative ratios of calories, protein, fat, saturated fat, carbohydrate, sugar, fibre and one or more vitamins and minerals are nutritionally balanced.

2. A product according to claim 1 in the form of a food product wherein the food product is an edible bar, cookie or biscuit.

3. A product according to claim 1 in the form of a beverage product wherein the beverage product is a shake or smoothie.

4. A product according to claim 1 wherein each complete serving of the product of this invention contains 33.3% of the recommended daily amount calories, protein, fat, saturated fat, carbohydrate, sugar, fibre and one or more vitamins and minerals

5. A product according to claim 1 wherein the ratio of complex carbohydrates to simple sugars is at least one to one.

6. A product according to claim 5 wherein the ratio of complex carbohydrates to simple sugars is three or more to one.

7. A product according to claim 1 containing a honey based sweetener.

8. A product according to claim 7 containing honey derived from the nectar of leptospermum scoparium.

9. A product according to claim 7 further containing natural sugars derived from fruit.

10. A product according to claim 1 further comprising sweet or savoury flavouring agents.

11. A product according to claim 1 wherein the fat derives at least in part from one or more oils containing omega fatty acids.

12. A product according to claim 1 containing vitamins A, B1, B2, B6, B12, C, D, and E, niacin, foliate, calcium, iodine, iron, magnesium, phosphorus and zinc at levels corresponding to the nutritionally balanced levels of carbohydrate, fat, protein and fibre.

13. A product according to claim 2 wherein the product has the taste, texture and appearance of real food, contains largely natural ingredients, is free from genetically modified materials, and contains no artificial colours, artificial flavours or artificial preservatives.

14. A product according to claim 1 containing polydextrose.

15. A product according to claim 1 containing Acacia gum.

16. A product according to claim 13 which is substantially free of known allergens including gluten/wheat, lactose/dairy products, eggs and nuts and sesame seeds, and yeast.

17. A product according to claim 1 wherein each complete serving of the product of this invention contains calories, protein, fat, saturated fat, carbohydrate, sugar, fibre and one or more vitamins and minerals, in the same relative proportion, between 10% and 33.3% of the recommended daily amount.

18. A product according to claim 1 containing a low dextrose equivalent maltodextrin.

19. A product according to claim 18 wherein the maltodextrin has a dextrose equivalent of 10.

20. A product according to claim 18 further containing cornflour.

21. A product according to claim 2 wherein the product is sized and of a weight to facilitate being easily and conveniently carried by a consumer.

22. A product according to claim 21 wherein a serving of the product weighs between 50 grams and 250 grams.

23. A product according to claim 21 wherein a serving of the product occupies between 25 cm³ and 250 cm³ of volume.

24. A product according to claim 21 wherein each serving of the product is individually wrapped.

25. A product according to claim 21 wherein each serving comprises two separately wrapped half servings.

26. A product according to claim 25 wherein one half serving is savoury in flavour, and the other is sweet to taste, but each having the same level of recommended daily dietary needs.

27. A product according to claim 25 wherein each half serving contains a different level of the recommended daily dietary needs, but taken together combine to a specific proportion of the recommended daily dietary requirements.

28. A method of manufacture of a food product according to claim 2, the method comprising the steps of:
a: weighting out various individual ingredients including bulk dry ingredients, dry ingredients for use in formulating a syrup mixture, oils, fats, water and sugars, and preparing each ingredient according to the product requirements; and
b: tempering the bulk dry ingredients to bring them to room temperature or slightly above; and
c: pre-blending the dry ingredient components for use in formulating the syrup mixture to ensure homogeneity; then
d: blending the dry ingredient components for use in formulating the syrup mixture with the oils, fats, water and sugar and heating to a temperature less than 100° C.; then
e: mixing the heated syrup mixture with the bulk dry ingredients and blending to form a substantially homogeneous mix of predetermined density; then
f. forming the homogeneous mix into predetermined size pieces, wherein each piece contains substantially the same quantity of product mix as all of the others; then
h: wrapping each piece promptly to avoid take up of moisture from the air.

29. The method of claim 28 wherein the syrup mixture is heated to no more than 95° C. in step (d).

30. The method of claim 28 wherein the syrup mixture is at between 80° C. and 95° C. during step (e).

31. The method of claim 28 wherein the pieces of homogeneous mix may be formed at step (f) via a process which includes forming the mix into a sheet of even thickness and then cutting the sheet into the pieces.

32. The method of claim 28 wherein the pieces of homogeneous mix may be formed at step (f) via a process by an extrusion process.

33. The method of claim 28 wherein the pieces of homogeneous mix may be formed at step (e via a process, or by a moulding process.

34. A method of manufacture of a beverage product according to claim 3, the method comprising the steps of:
a: weighting out various individual ingredients including bulk dry ingredients, dry ingredients for use in formulating a syrup mixture, oils, fats, water and sugars, and preparing each ingredient according to the product requirements; and
b: tempering the bulk dry ingredients to bring them to room temperature or slightly above; and
c: pre-blending the dry ingredient components for use in formulating the syrup mixture to ensure homogeneity; then
d: blending the dry ingredient components for use in formulating the syrup mixture with the oils, fats, water and sugar and heating to a temperature less than 100° C.; then
e: mixing the heated syrup mixture with the bulk dry ingredients and blending to form a substantially homogeneous mix of predetermined density; then
f: blending the homogeneous mix with a predetermined quantity of water to form a substantially smooth and homogeneous fluid; then
g: dispensing predetermined volumes of the fluid into packaging containers.

35. The product of claim 1 substantially as herein described or exemplified.

36. The method of claim 28 substantially as herein described or exemplified.

37. The method of claim 34 substantially as herein described or exemplified.
